(19) United States
(12) Patent Application Publication
(10) Pub. No.: US 2002/0087530 A1
(43) Pub. Date: Jul. 4, 2002

(54) System and method for publishing, updating, navigating, and searching documents containing digital video data

(75) Inventors: Eric James Markson Smith, Toronto (CA); Ronald Michael Baecker, Hamilton (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Expresto Software Corp., Toronto (CA)

(21) Appl. No.: 10/022,540

(22) Filed: Dec. 20, 2001

Related U.S. Application Data
(60) Provisional application No. 60/258,541, filed on Dec. 29, 2000.

(51) Int. Cl. G06F 17/30

(52) U.S. Cl. 707/3

(57) ABSTRACT

A system and method for publishing, updating, navigating, and searching multimedia documents having a hierarchical structure and comprising digital video data. In one aspect of the present invention, a method of publishing multimedia documents comprises the steps of creating a movie from a multimedia document, processing the movie by partitioning the movie into multiple movie components, and generating one or more output documents capable of being processed by a web browser for viewing by a user, where a user can receive output from movie components as selected by the user.

### FIELD OF THE INVENTION

This invention relates generally to multimedia documents comprising digital video data. More specifically, this invention relates to a system and method for adapting multimedia documents having a hierarchical structure for use in various computer and web-based applications.

### BACKGROUND OF THE INVENTION

Advances in data networking and computing equipment technology have permitted greater flexibility in the use of digital video technology in computer and web-based applications. In particular, a demand exists for multimedia applications (i.e., applications which support a variety of media formats including digital video, audio, graphics, text, etc.) which can be accessed by a user over the Internet using a web browser.

A multimedia document comprising digital video data can be used to generate a multimedia presentation to a user for viewing. These multimedia documents (i.e. “movies”) typically contain digital video data in the form of a video data stream or series of video frames, and an audio data stream or audio track to be synchronized with the video data and played during the display of video data. Such multimedia documents comprising digital video data, audio data, and optionally other data stored in serial format have been used in a variety of prior art applications designed to facilitate the viewing, browsing and manipulating of the contents of the multimedia documents.

U.S. Pat. No. 5,521,841 issued to Arman et al. discloses a method for allowing the user to rapidly browse a video sequence by pre-processing the linear video sequence of frames to detect scene changes, and constructing a series of frames representative of multiple images within the video sequence for viewing by a user.

U.S. Pat. No. 5,682,326 issued to Klingler et al. discloses a system for displaying various multimedia elements including video and audio data, transitions, and special effects in a multi-window environment where a user can edit a digital movie. In one window, digitized video clips (i.e. source clips) or more specifically, references to portions thereof (i.e. reference clips) are represented as a set of multiple linear tracks, each track being associated with the data of a specific multimedia element.

U.S. Pat. No. 5,821,945 issued to Yeo et al. discloses a method for decomposing a linear sequence of video frames into groups of frames, and representing each group of frames as a node in a graph displayed to a user to facilitate the browsing of the video frames. A series of mathematical algorithms are used to determine related video frames from the sequence, and each group of related video frames is represented as a node in a hierarchical “scene transition” graph.

U.S. Pat. No. 5,884,056 issued to Steele discloses a web-based system and method for browsing a series of frames stored in a video data object. The system permits a user to browse a sequence of thumbnail representations of selected frames within the series. The user can make a request to view intermediate frames between two selected frames in the sequence, resulting in the display of a new sequence of thumbnail representations of frames within the series of intermediate frames. This request can be repeated on the new sequence, allowing a user to examine any part of any displayed sequence in greater detail.

U.S. Pat. No. 5,995,095 issued to Ratakonda discloses a method for processing a digital video signal for a digital video sequence, and subsequently generating a summary of the video sequence from selected frames in the sequence at different levels of summary detail using a hierarchical model. Selecting a frame for browsing at the most detailed summary level results in the playback of a segment of the actual video sequence.

U.S. Pat. No. 6,006,241 issued to Purnaveja et al. discloses a method for generating an annotation stream of text and/or graphical data, the output of which can be synchronized to the display of video data on a web page.

U.S. Pat. No. 6,026,389 issued to Nakajima et al. discloses a system which allows a sequence of frames of a motion picture to be rapidly browsed in a web browser. A Macro Browser window is used to browse the sequence in larger “macro” increments, while a Micro Browser window is used to query images at a higher level of detail, in smaller “micro” increments.

U.S. Pat. No. 6,115,035 issued to Compton et al. discloses a system and method for translating analog audio and video signals into digital signal segments, and to archive and distribute these digital signal segments to a web server.

Unfortunately, many of the above prior art systems and methods require significant subsequent processing of the digital video data in multimedia documents (which is typically stored in the form of a linear sequence of frames) after the documents have been created to convert the data into a form suitable for use in the desired application (e.g., browsing, editing, etc.).

### SUMMARY OF THE INVENTION

The present invention relates to a system and method for publishing, updating, navigating, and searching multimedia documents having a hierarchical structure and comprising digital data.

One aspect of the present invention is directed to a system and method for searching a multimedia document, wherein the method comprises the steps of performing a search of the text data in the multimedia document according to a user-defined query, and displaying the results of the search.

Another aspect of the present invention is directed to a system and method of using digital video data to answer frequently asked questions, wherein digital video data associated with an answer to a user-selected frequently asked question is retrieved and outputted to the user.

Another aspect of the present invention is directed to a system and method for publishing multimedia documents, wherein the method comprises the steps of creating a movie from a multimedia document partitioning the movie into multiple movie components, and generating one or more output documents capable of being processed by a web browser for viewing by a user, whereby a user can receive output from movie components as selected by the user.

Another aspect of the present invention is directed to a system and method for navigating multimedia documents, wherein the method comprises the steps of creating a navigation index for the multimedia document, retrieving data from the multimedia document based on a user-selected index element in the navigation index, and outputting the retrieved data.

Another aspect of the present invention is directed to a system and method for updating multimedia documents, wherein the method comprises the steps of retrieving data from a selected structural element of the multimedia document, modifying the data, and storing the modified data in the structural element of the multimedia document.

### BRIEF DESCRIPTION OF THE DRAWINGS

For a better understanding of the present invention and to show more clearly how it may be carried into effect, reference will now be made by way of example, to the accompanying drawings which show a preferred embodiment of the invention, and in which:

FIG. 1 illustrates the hierarchical structure of a multimedia document;

FIG. 2 illustrates data elements which may be found in a multimedia document;

FIG. 3 is a screenshot from a prior art application which uses a multimedia document having a hierarchical structure;

FIG. 4A is a schematic diagram illustrating a system for searching a multimedia document having a hierarchical structure;

FIG. 4B is a flowchart illustrating the steps in a method of searching a multimedia document having a hierarchical structure;

FIG. 5A is a schematic diagram illustrating a system for using digital video data in answering frequently asked questions;

FIG. 5B is a flowchart illustrating the steps in a method of using digital video data in answering frequently asked questions;

FIG. 6A is a schematic diagram illustrating a system for publishing multimedia documents to the web;

FIG. 6B is a flowchart illustrating the steps in a method of publishing multimedia documents to the web;

FIG. 7 is a screenshot illustrating a web page with a table of contents generated from a system for publishing multimedia documents to the web;

FIG. 8 is a screenshot illustrating a web page with thumbnail graphics in a “visual tree” format generated from a system for publishing multimedia documents to the web;

FIG. 9A is a schematic diagram illustrating a system for navigating a multimedia document having a hierarchical structure;

FIG. 9B is a flowchart illustrating the steps in a method of navigating a multimedia document having a hierarchical structure;

FIG. 10A is a schematic diagram illustrating a system for updating a multimedia document having a hierarchical structure; and

FIG. 10B is a flowchart illustrating the steps in a method of updating a multimedia document having a hierarchical structure.

### DETAILED DESCRIPTION OF THE INVENTION

The present invention relates to a system and method for representing multimedia documents containing a variety of multimedia elements including digital video data in a format suitable for use in various applications. In particular, the present invention relates to applications which use multimedia documents that have been created having a hierarchical structure.

Advantageously, the hierarchical structure allows the contents of the multimedia documents to be manipulated as modular units for use in a wide variety of applications. This method of representing multimedia documents comprising digital video data has been described in Baecker, R. M. et al., A Multimedia System for Authoring Motion Pictures, Proceedings of ACM Multimedia'96, 31-42, and Rosenthal, A. J. and Baecker, R. M., Multimedia for Authoring Motion Pictures, Proceedings Graphics Interface'94, 133-140, for example.

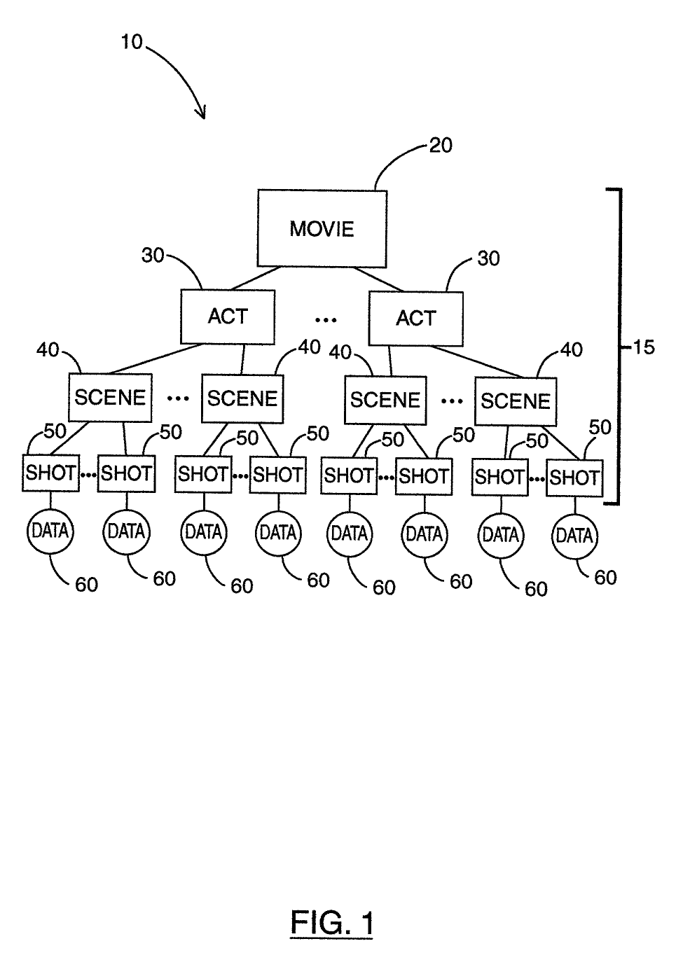

Referring to FIG. 1, the structure of a typical multimedia document having a hierarchical structure is shown generally as 10. Although conceptually, as described herein, the multimedia document 10 has a hierarchical structure, physically the multimedia document 10 consists of multiple files. Some of these files are documents that define the framework of the multimedia document 10, while other files store the actual data of which the multimedia document 10 is comprised. The documents that define the framework of the multimedia document 10 can be written in Structured Multimedia Production Language (SMPL), a variant of Extensible Markup Language (XML) devised by the assignee of the present invention. In variant embodiments of the present invention, the documents that define the framework of the multimedia document 10 can be expressed in other languages, such as Structured Multimedia Integration Language (SMIL), for example.

The structure of the multimedia document 10 is defined by numerous structural elements 15 linked together in a hierarchical or tree-like model. A structural element 15 is a data structure that contains a list of lower-level structural elements, and optionally, data. Preferably, these structural elements 15 are given designations such as movie, act, scene, and shot in the manner of a Hollywood-style script, although different designations may be defined. At the highest level of the hierarchy, the multimedia document 10 can be represented as a structural element 15 designated as a movie 20. The movie 20 is comprised of multiple structural elements 15 of lesser size, designated as acts 30. Similarly, each act 30 is comprised of one or more structural elements 15 designated as scenes 40, and each scene 40 comprises one or more structural elements 15 designated as shots 50. Each shot 50 contains multimedia data 60. In variant embodiments of the invention, higher-level structural elements such as acts 30 or scenes 40 may also contain multimedia data 60.

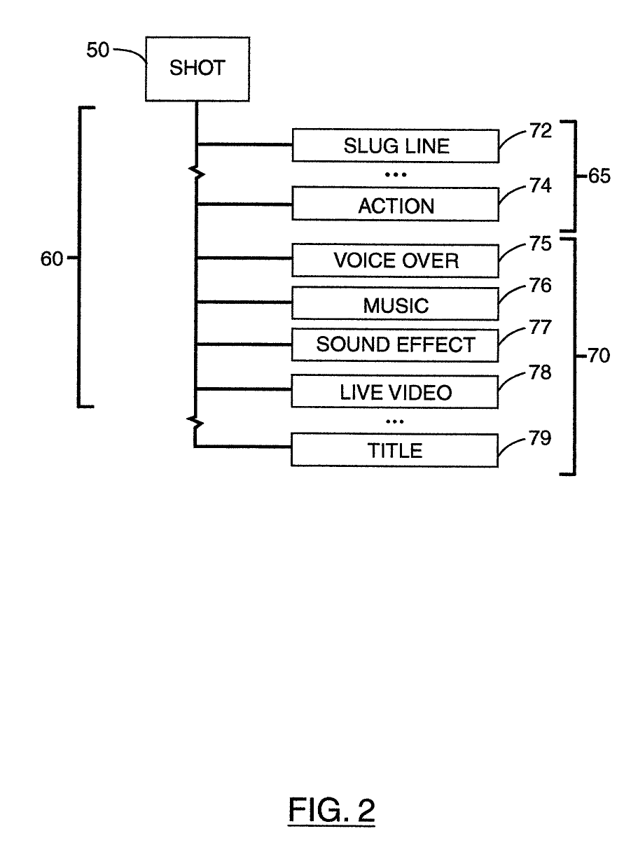

Referring to FIG. 2, the lowest level structural element 15 of the multimedia document 10, which in the embodiment illustrated in FIG. 1 is designated as a shot 50, stores the multimedia data 60 of the multimedia document 10. The data 60 can be stored in various types of elements, including text elements 65 and content elements 70.

Optionally, higher-level structural elements 50 of the multimedia document 10 may also comprise text elements 65 and/or content elements 70.

Text elements 65 store descriptive data related to the associated shot 50, in text format. Text elements 65 can include, for example, a slug line 72 and an action description 74. The data 60 for the associated shot 50 can also be stored in content elements 70 which contain multimedia data in various formats. Each content element 70 contains timing information as well as other descriptive information relating to the multimedia data stored in the particular content element 70. The multimedia data of each content element 70 is classified according to its purpose or “treatment”. Treatments may include, for example, voiceover 75, music 76, sound effects 77, live video 78, synthetic video (not shown), title 79, and transition (not shown).

Content elements 70 may also be classified as external or internal. An external content element is a reference to a digital representation of sound and/or video, and is typically stored in the form of a movie file, image file or a sound file. An internal content element contains text that can be either descriptive in nature (e.g., annotation, dialogue, director's notes) or functional in nature (e.g., transitions, effects).

In summary, the multimedia document 10 is represented as a hierarchical data structure, which is initialized and populated during the process of creating the multimedia document 10. During the creation process, an author of the multimedia document 10 indicates the role of each structural element 15, text element 65, and content element 70, and provides descriptive information pertaining to those elements. In particular, the addition of descriptive information to digital video is not done after the fact, as in prior art video annotation processes. In the present invention, the inclusion of descriptive data in a multimedia document 10 is an integral part of the authoring or creation process, permitting the data 60 in a multimedia document 10 to be used in a variety of applications, and allowing the data 60 in the multimedia document 10 to be modified without requiring the structure of the multimedia document 10 to be significantly changed.

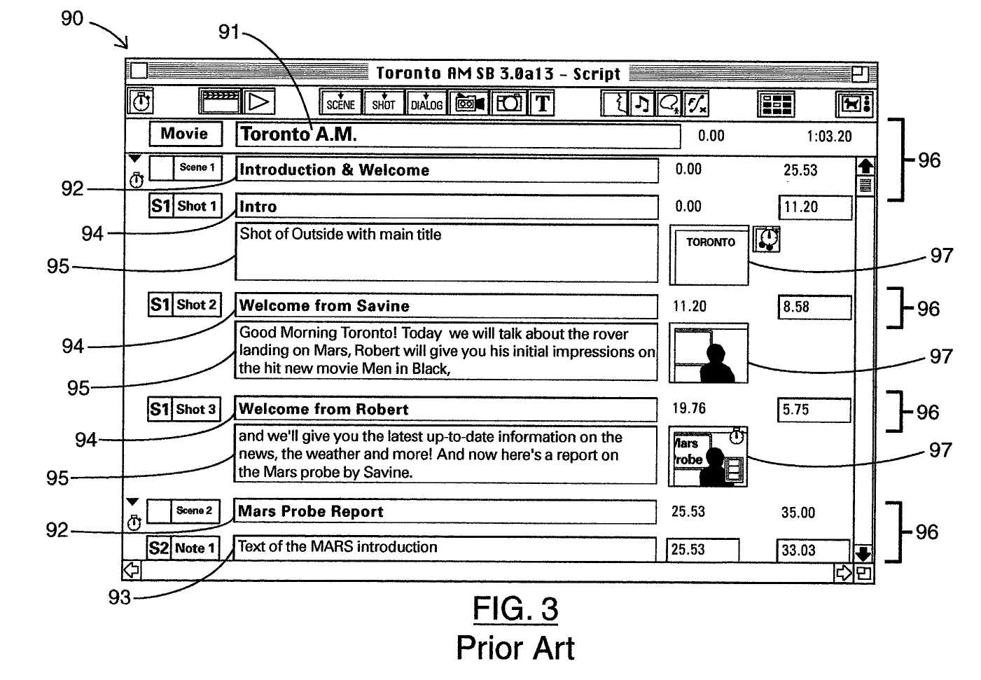

For example, referring to FIG. 3, a screenshot of a prior art video application which displays data 60 in a multimedia document 10 having a hierarchical structure, is shown generally as 90. This application facilitates the creation and inspection of multimedia documents 10 by displaying, for example, a movie title 91, scene titles 92, scene notes 93, shot titles 94, shot descriptions 95, timing information 96, and graphic thumbnail images 97.

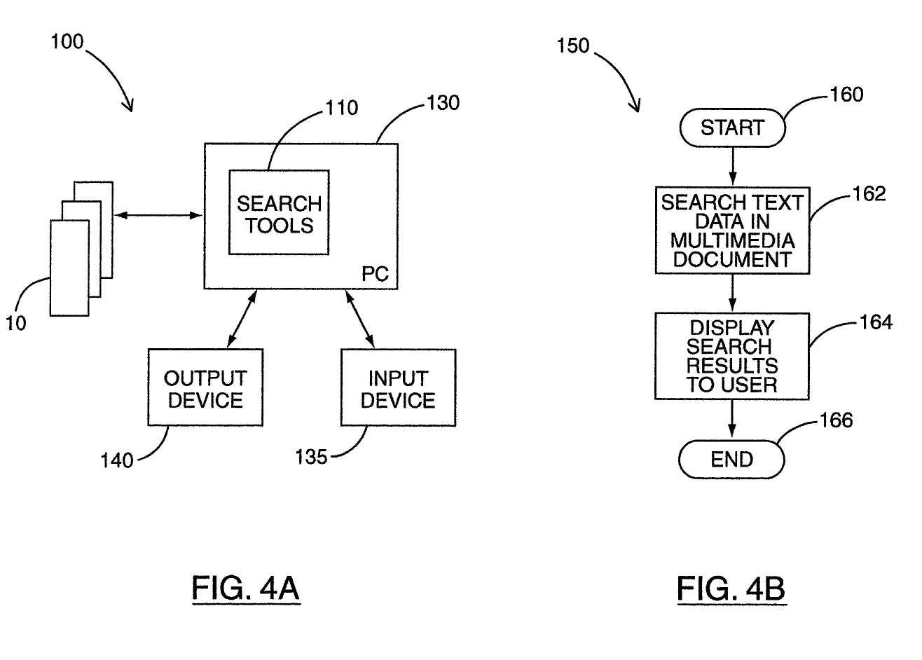

Referring to FIG. 4A, a system for searching a multimedia document 10 having a hierarchical structure, designed in accordance with the present invention, is shown generally as 100. Search system 100 is a further example of an application that utilizes the features of multimedia documents 10 having a hierarchical structure. Search system 100 searches text data stored in text elements 65 and content elements 70 of a multimedia document 10 using text-based search engines or search tools 110 as is known, or customized search engines or search tools (not shown) designed to search and/or index the text data stored in a multimedia document 10. The search tools 110 may exist as part of a software application executing on a personal computer (PC) 130, for example. Search tools 110 that accept user-defined queries entered through an input device 135 can be used to search the text data of the multimedia document 10. The results of the search can then be displayed to a user through an output device 140 connected to the PC 130. Output device 140 may be a web browser, for example. Alternatively, the search results may be transmitted to another application module (not shown) for subsequent processing.

Optionally, text data in the multimedia document 10 can be stored in a database (not shown).

Referring to FIG. 4B, a method of searching a multimedia document 10 having a hierarchical structure is shown generally as 150 and commences at step 160.

At step 162, the text data in the multimedia document 10 is searched using search tools 110, preferably according to a user-defined query provided through input device 135.

At step 164, results obtained from the search performed at step 162 are displayed to a user through an output device 140, such as a web browser. In variant embodiments of the invention, the results of the search performed at step 162 may be transmitted to another application module for subsequent processing at step 164.

Step 166 marks the end of the method for searching a multimedia document 10 having a hierarchical structure.

The system 100 of FIG. 4A and the method 150 of FIG. 4B for searching a multimedia document 10 having a hierarchical structure have the advantage of allowing text to be searched more efficiently as compared to other systems and methods for searching video documents that require significant processing of the video documents into a text format after the creation of those video documents. The processing may include, for example, manual text extraction or annotation of the video documents, or the application of voice recognition algorithms to convert the video documents into text.

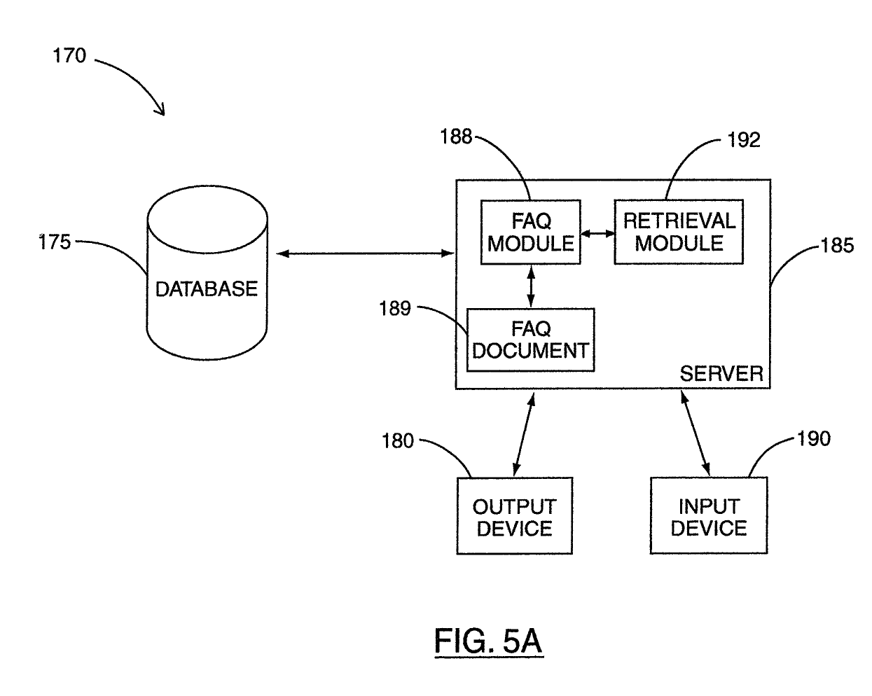

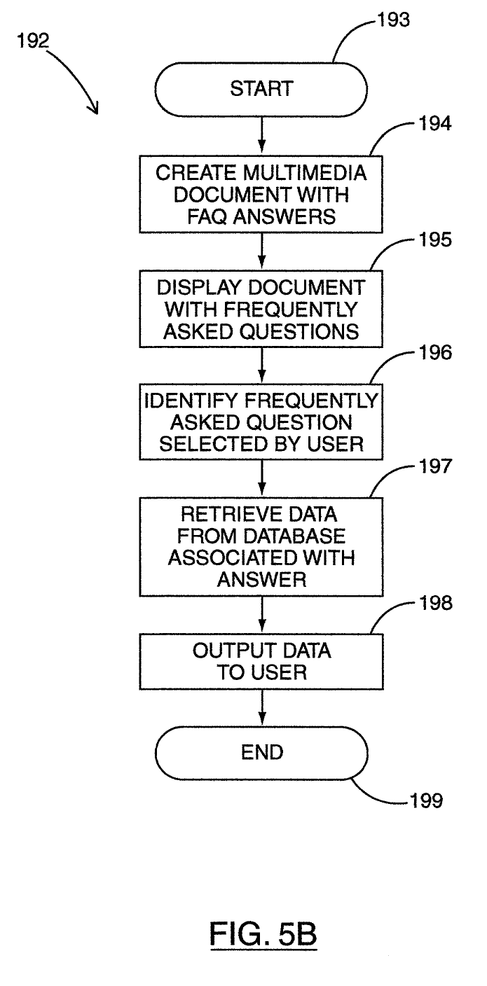

Referring to FIG. 5A, a system for using digital video data to answer frequently asked questions, designed in accordance with the present invention, is shown generally as 170. System 170 is another example of an application that utilizes the features of multimedia documents 10 having a hierarchical structure. Answers to a user-selected frequently asked question selected from a set of frequently asked questions (FAQ) displayed to a user on a web page, can be presented to the user using digital video data stored in a multimedia document 10. Preferably, the answers to a user-selected frequently asked question is displayed to the user in a web browser.

More specifically, the system 170 comprises a database 175 for storing digital video data of the multimedia document 10. An output device 180 (e.g., web browser) is connected to a server 185 comprising a FAQ module 188 for displaying a document 189 of frequently asked questions to a user. The FAQ module 188 then receives input from the user through input device 190 identifying a user-selected frequently asked question contained in the document 189. A retrieval module 192 retrieves data, including digital video data, associated with the answer to the user-selected frequently asked question from the database 175, and outputs the data to the user through the output device 180. FAQ module 188 and retrieval module 192 can reside on the same server 185 or on different servers.

Referring to FIG. 5B, a method of using digital video data to answer frequently asked questions is shown generally as 192, and commences at step 193.

At step 194, a multimedia document 10 having a hierarchical structure is created which contains data, including digital video data, that can be used to provide answers to frequently asked questions displayed on a web page.

At step 195, a document 189 containing frequently asked questions is displayed to a user on a web page.

At step 196, input is received from the user. The input identifies a user-selected frequently asked question contained in the document 189.

At step 197, data in the multimedia document 10 associated with an answer to the user-selected frequently asked question is retrieved from the database 175.

At step 198, data retrieved at step 197 is outputted to the user through an output device 180. Alternatively, the data can be directed to another application module for further processing before being outputted to the user.

Step 199 marks the end of the method of using digital video data to answer frequently asked questions.

The system 170 of FIG. 5A and the method 192 of FIG. 5B for using digital video data to answer frequently asked questions advantageously permit users to be shown how to perform tasks, for example, using motion pictures. This can be more effective than other systems and methods for answering frequently asked questions that are solely text-based, as the use of digital video data can facilitate greater understanding of the answers. Further, the method 192 of using digital video data to answer frequently asked questions can be more engaging to the user than methods which only use text to answer frequently asked questions.

In accordance with the present invention, the multimedia document 10 having a hierarchical structure may also be published or exported to the web, whereby a collection of web pages constituting a complete Internet web site can be generated from the multimedia document 10. Publishing multimedia documents to the web allows media-rich web sites to be created, and makes it possible for users to explore a complex multimedia document using a standard web interface which they will already be familiar with. Advantageously, since the data in the multimedia document 10 is already highly modular and arranged in a hierarchical structure, it is possible for the user to view desired portions of the multimedia document 10 as a movie presentation, without having to download the entire movie. Thus, segments of a multimedia document 10 can be quickly accessed by a user, while the download time required is minimized. This can be particularly advantageous where the multimedia document 10 is large and where the speed at which data can be downloaded to a user's computer is limited.

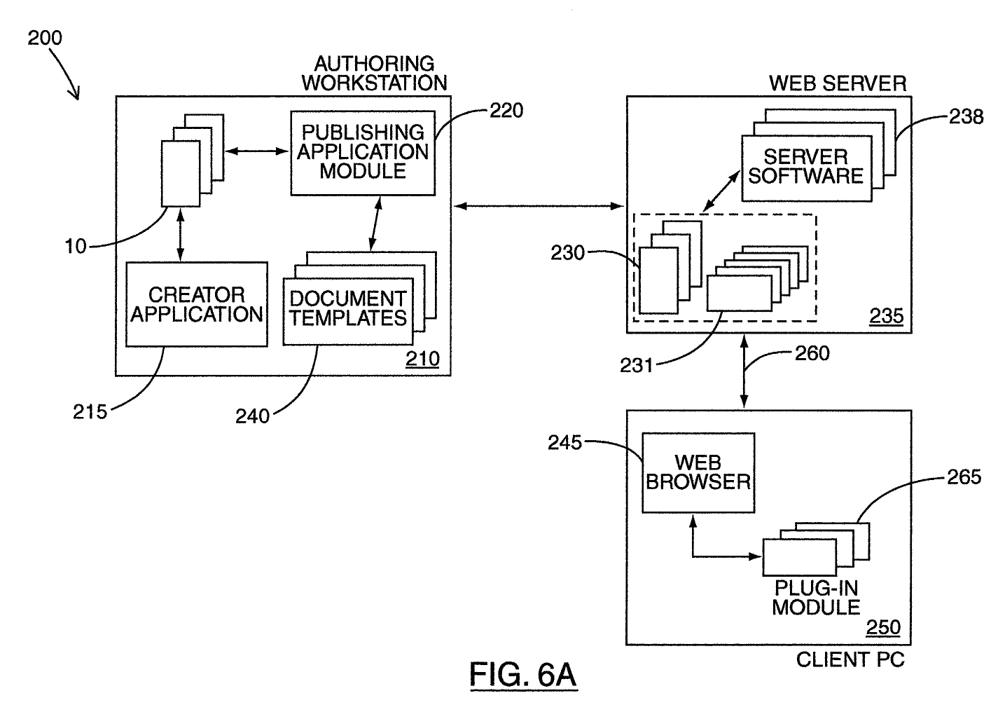

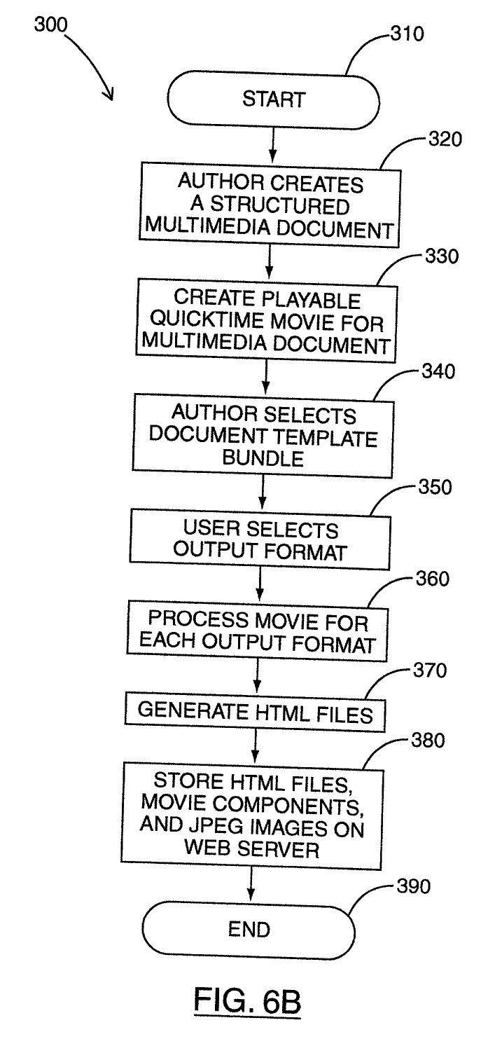

Referring to FIG. 6A, a system for publishing multimedia documents to the web is shown generally as 200. Publishing system 200 comprises an authoring workstation 210 in which the files associated with a multimedia document 10 having a hierarchical structure are stored. A creator application 215 can be executed by a user to create a movie representation of a multimedia document 10. A publishing application module 220 can be executed to publish the multimedia document 10 to the web. More specifically, the publishing application module 220 creates a collection of web pages 230 and associated data files 231 which will be used to display the content of the multimedia document 10 to users. The web pages 230 and associated data files 231 can be stored on a web server 235. Web server software modules 238 also reside on web server 235. Web server software modules 238 control the operations of the web server 235 and the web pages 230 stored thereon.

The web pages 230 are created in HyperText Markup Language (HTML) in the preferred embodiment of the invention. The web pages 230 are created using a collection or bundle of document templates 240, wherein each document template 240 corresponds to one or more types of structural elements 15 defined in the SMPL-based multimedia document 10. The document template 240 is a document written in a modified form of HTML containing defined substitution tags. Substitution tags are markers within a document template 240 that describe how to transform information contained in structural elements 15 into ordinary HTML.

The web pages 230 are processed by a web browser 245 residing on a client PC 250 connected to the web server 235 through a network connection 260, preferably an Internet connection. Plug-in modules 265 capable of being used in conjunction with the web browser 245 may also reside on the client PC 250. Plug-in modules 265 are used to display data having different formats on the web browser 245. For example, the format of the web pages 230 or data files 231 being downloaded to a web browser 245 may be in one of the following formats which require decoding by a plug-in module 265: QuickTime, AVI, Windows Media, RealMedia.

Plug-in modules 265 may also be used to decompress data downloaded into the web browser 245 that has been previously compressed during the process of publishing the web pages 230.

Referring to FIG. 6B, a method for publishing multimedia documents 10 to the web is shown generally as 300, and commences at step 310.

At step 320, an author creates a multimedia document 10 having a hierarchical structure, as depicted in FIGS. 1 and 2, for example.

At step 330, publishing application module 220 creates a playable QuickTime movie for the multimedia document 10. After an instance of a QuickTime movie object is generated and initialized, the movie is created by recursively processing each structural element 15 in the multimedia document 10 as follows:

a) For each content element 70 directly associated with the structural element 15 being processed, zero or more tracks are generated with the appropriate media data and timing information for that content element 70. Each track includes a stored indication of the desired treatment based on the type of the content element 70. For example, if the content element 70 comprised the data of an imported audio file, a single track containing the audio data would be generated.

b) Each of the lower-level structural elements of the given structural element 15 is processed recursively in the same fashion.

As a result, all content elements 70 of the multimedia document 10 will ultimately be processed and multiple sets of tracks will be created.

While in the preferred embodiment of the invention a QuickTime movie is created and processed, in variant embodiments of the invention, movies or documents of other formats may be used.

At step 340, the author selects one or more document templates (i.e. a document template bundle) from a selection of document templates 240.

At step 350, the author can select one or more desired output multimedia formats from a variety of available formats, so that media (data) files 231 and web pages 230 for the selected formats can be generated in the selected output multimedia formats. For example, available formats may include QuickTime, AVI, Windows Media, and Real Media. A default multimedia format may be defined and used in the event that no user selection has been made.

At step 360, the QuickTime movie created at step 330 is processed by the publishing application module 220, for each output multimedia format selected at step 350, as follows:

a) For each treatment (e.g. Live Video, Voiceover, etc.) found within the document, the author can select a compression algorithm to be used to the data in associated tracks. In variant embodiments of the invention, the publishing application module 220 may be programmed to determine an optimal compression algorithm to be used for different treatments, based on pre-determined criteria (e.g. maximum compression, minimum compression time, etc.) Advantageously, the present invention permits different compression algorithms to be used on different treatments. It is not necessary to use only one compression algorithm for compressing data in a given movie.

b) The movie is divided into several sub-movies based on the number of treatments.

c) Each sub-movie is compressed according to a compression algorithm selected in (a), if any, to generate an output sub-movie.

d) The output sub-movies are merged into an output movie.

e) The output movie is divided into movie components (i.e. “chunks”) based on the timing of the structural elements in the multimedia document 10.

f) For each movie component, a JPEG thumbnail image can be generated.

As a result, the output movie will contain all the media in the QuickTime movie originally generated at step 330, but in a compressed form suitable for transmission over the Internet. The output movie has also been divided into movie components or chunks, to permit a user to load only a small portion of the movie, if desired. For instance, a user can view a specific scene of a specific act of the movie representation of the multimedia document 10, without having to download the entire output movie.

At step 370, HTML output files (i.e. web pages 230) are generated for each output format selected at step 350. This comprises the step of traversing the structural elements 15 of the multimedia document 10, processing each structural element 15 as follows:

For each structural element 15, if there is a template within the template bundle that corresponds to the structural element 15:

a) The template is first processed by searching for substitution tags in the template;

b) For each substitution tag within the template, HTML code is generated based on the combination of substitution tags, the data content of the structural element 15, and the multimedia format being processed; Substitution tags are used to generate text, links to other HTML documents, embedded images, and references to movie components generated at step 360; and

c) The resultant HTML document derived from the working of the template upon the structural element 15 is written out as an ordinary HTML file.

As a result, a collection of HTML files (i.e. web pages 230) and data files 231 (i.e. movie components and JPEG images) have been created. This collection constitutes a complete web site representation of the original multimedia document 10. The web pages 230, movie components, and JPEG images can subsequently be stored on a web server 235 at step 380, and optionally integrated into an existing web site.

Step 390 marks the end of the method of publishing multimedia documents 10 to the web.

Upon loading the web pages 230 into a web browser 245, it may be necessary to decompress compressed data before a movie component can be viewed by a user.

Depending on the template used, the visual appearance of the web pages will typically differ. For example, titles and/or other textual descriptive information, and more generally, the contents of any text element 65 and/or content element 70 may be integrated into the web pages in a variety of layouts and styles.

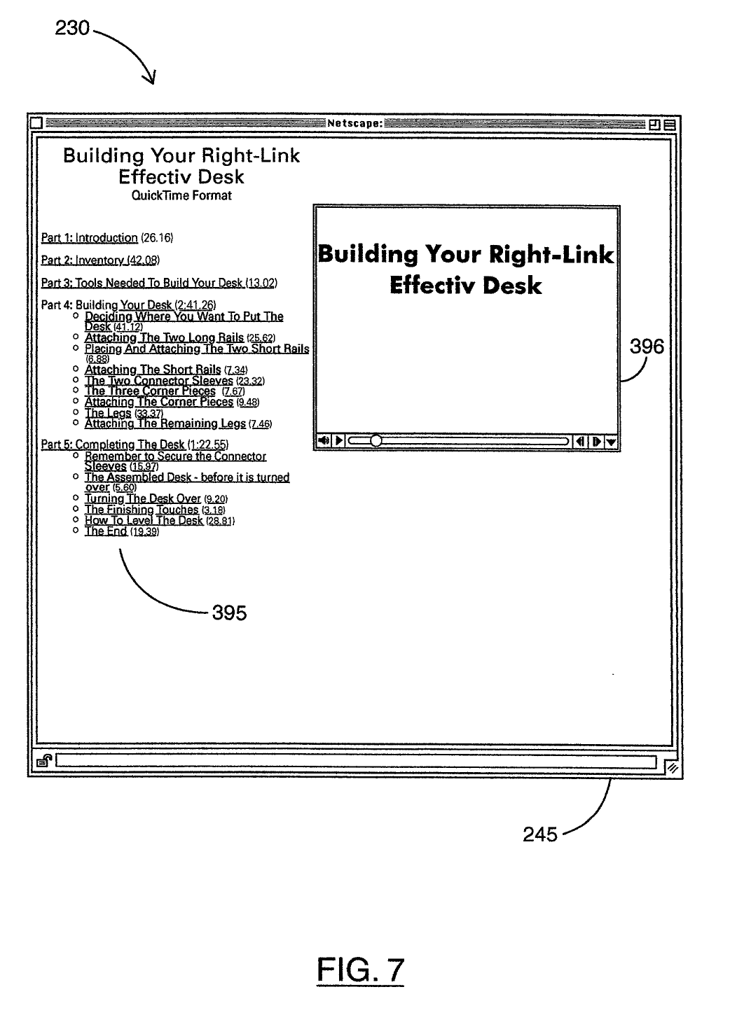

For example, a web page 230 that incorporates titles in the format of a table of contents as illustrated in FIG. 7 can be generated by the present invention. A table of contents 395 can appear on the same page as a movie display 396 or in a separate frame within the web browser 245. The titles of the table of contents 395 can appear in the web page 230 as hyperlinks, which can be selected to permit the user to request output of one or more movie components.

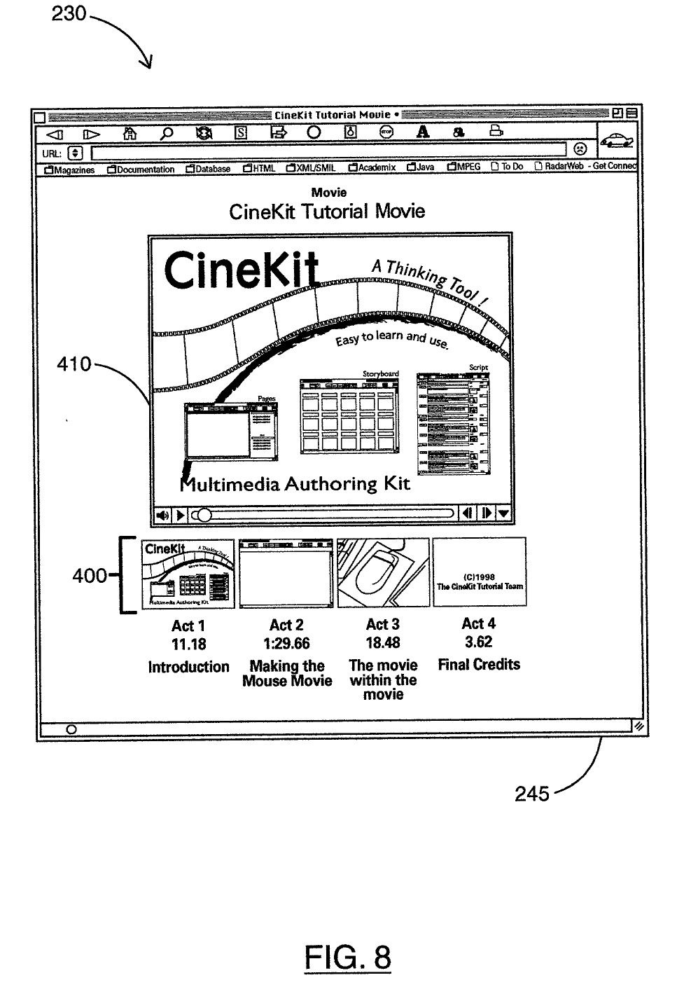

As a further example, a web page 230 that displays thumbnail graphic images in the form of a “visual tree” displayed in a web browser 245 as illustrated in FIG. 8 can be generated by the present invention. By clicking on a thumbnail graphic image 400 below the movie display 410, the movie component pertaining to a specified act, scene, or shot can be viewed in the movie display 410.

In variant embodiments of the invention, the method of the present invention may be embodied in a computer-readable medium or in a data stream.

In variant embodiments of the invention, an extension of the publishing system 200 can be implemented whereby “videograms” are supported. A specialized template bundle is used to generate a single page of HTML data that gives an overview of the multimedia document 10. This HTML page is then transmitted to a user as an electronic mail message (i.e. a “videogram”). When the user receives the videogram, they will be able to select hypertext links within the message to view desired portions of a multimedia web site generated in accordance with the present invention.

In variant embodiments of the invention, “variant” elements may be used within elements of a multimedia document 10 to facilitate the publishing of the multimedia document 10 to the web in different output formats. For example, a variant element can be a data structure containing sufficient information to permit web pages to be generated in several different languages (e.g. French and English). In this way, the same multimedia document 10 can be used to publish several complete web sites, each being in a different language. Variant elements may also be designed to permit the publishing of multimedia documents 10 to the web for different operating systems, data transfer rates, or expertise levels (i.e. level of a user's computer knowledge), for example.

In variant embodiments of the invention, the publishing system 200 may generate output documents in alternative formats. The HTML output from the publishing system 200 could be replaced with Structured Multimedia Integration Language (SMIL) documents, Wireless Markup Language documents, or other types of Extensible Markup Language (XML) documents.

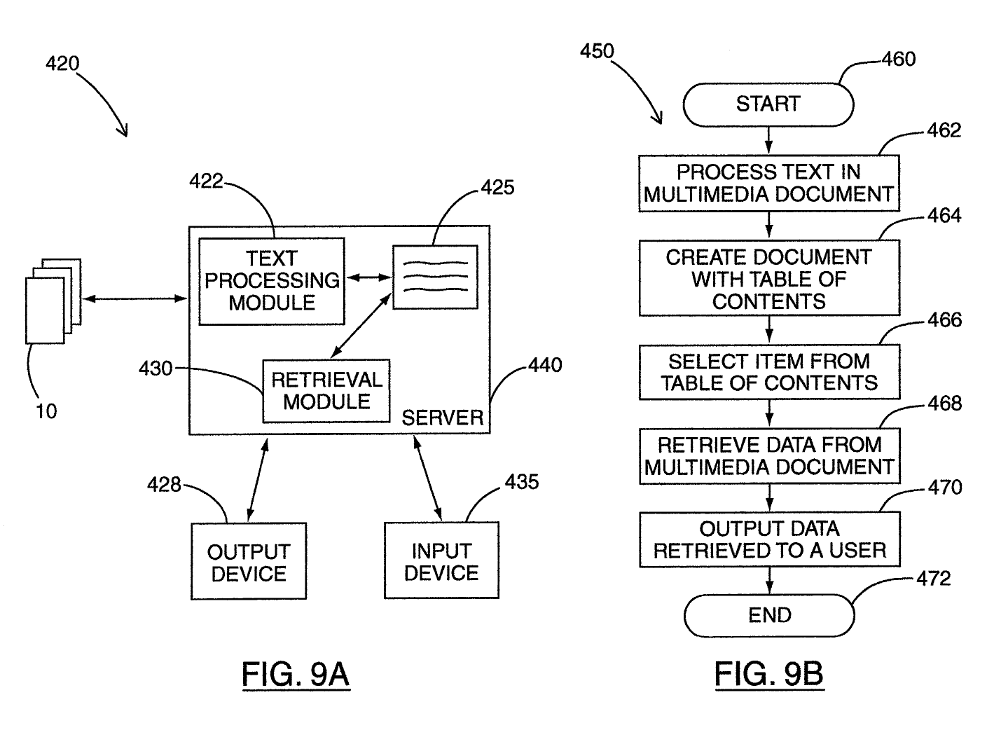

Referring to FIG. 9A, a system for navigating a multimedia document 10 having a hierarchical structure, designed in accordance with the present invention, is shown generally as 420. Navigation system 420 is a further example of an application that utilizes the features of multimedia documents 10 having a hierarchical structure. Navigation system 420 uses a text processing module 422 for retrieving text data in a multimedia document 10 and creating a navigation index 425 that can be displayed to a user through an output device 428. The output device 428 can be, for example, a web browser. In that case, the navigation index 425 can be incorporated into a web page (not shown).

The navigation index 425 can be used by a user to quickly retrieve data in the multimedia document 10. The navigation index can be for example, in the form of a table of contents (e.g. as shown in FIG. 7) or an index. The navigation index 425 comprises index components (not shown) which can be selected by a user, and which are associated with the data of a structural element 15 within the multimedia document 10. An index component, for example, can be a title or description associated with a specific structural element 15. A retrieval module 430 can retrieve data from the structural element 15 associated with an index component selected by the user through an input device 435. The data retrieved by the retrieval module 430 can be displayed to a user through the output device 428. The text processing module 422, navigation index 425 (or a document comprising a navigation index 425), and retrieval module 430 can reside, for example, on a server 440.

Referring to FIG. 9B, a method of navigating a multimedia document 10 having a hierarchical structure is shown generally as 450 and commences at step 460.

At step 462, the text data in the multimedia document 10 is processed by the text processing module 422.

At step 464, a navigation index 425 such as a table of contents is created by the text processing module. The navigation index 425 can be incorporated into a document such as a web page, for example.

At step 466, a user selects an index element from the navigation index 425. The index element is associated with data of a structural element 15 in the multimedia document 10.

At step 468, the data of the structural element 15 with which the index element selected at step 466 is associated is retrieved by retrieval module 430. The retrieval module 430 may be programmed to retrieve only certain types of data (e.g., title only, video only, etc.) stored in that structural element 15.

At step 470, data retrieved by the retrieval module 430 at step 468 is displayed to a user.

Step 472 marks the end of the method for navigating a multimedia document 10 having a hierarchical structure.

The system 420 of FIG. 9A and the method 450 of FIG. 9B for navigating a multimedia document 10 having a hierarchical structure have the advantage of allowing a user to browse a compact outline view of a complex video document, in order to select data that the user desires to view without requiring the entire multimedia document 10 to be searched, and without requiring the user to construct or guess search terms that may be required to retrieve the desired data.

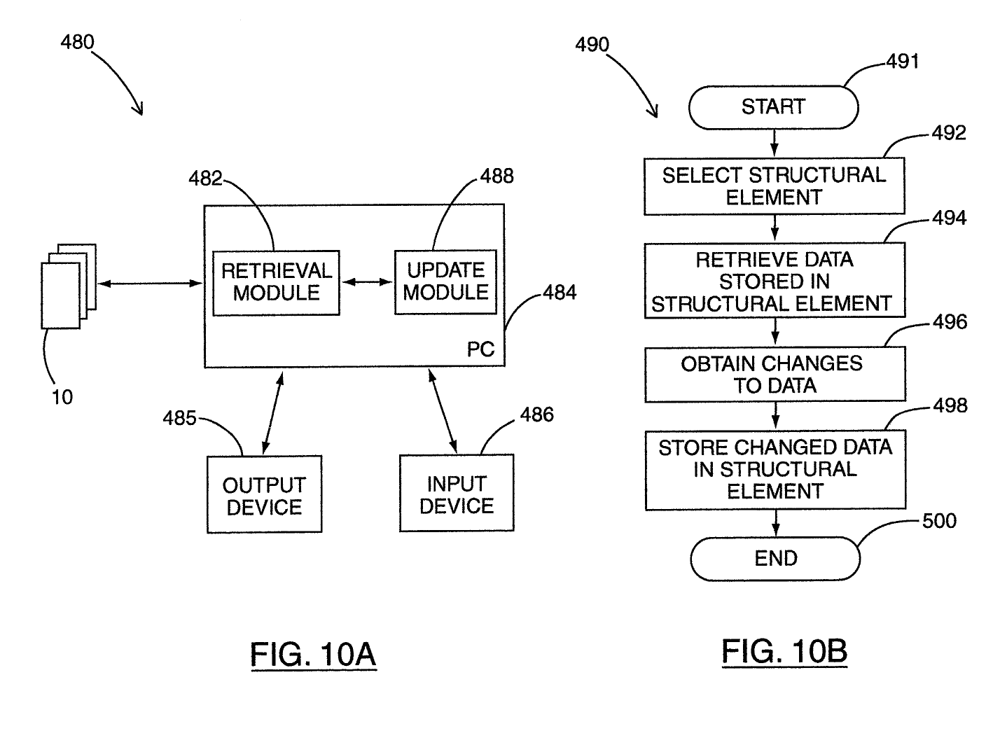

Referring to FIG. 10A, a system for updating a multimedia document 10 having a hierarchical structure, designed in accordance with the present invention, is shown generally as 480. System 480 is a further example of an application that utilizes the features of multimedia documents 10 having a hierarchical structure. System 480 allows data stored in text elements 65 and content elements 70 of the multimedia document 10 to be updated, utilizing the benefits of the hierarchical structure of multimedia document 10. The data may be updated by a retrieval module 482 residing on a PC 484. Retrieval module 482 facilitates the retrieval of data stored in a multimedia document 10, and can display the data in an output device 485. Through an input device 486, a user can select a structural element 15 containing data that the user wishes to edit. Update module 488, also residing on PC 484, can accept modifications of the data retrieved by retrieval module 482 from the user, and can store the modified data in the selected structural element 15 of the multimedia document 10. The data retrieved by the retrieval module 482 can be modified by changing the data, adding data to the data retrieved by the retrieval module 482, and/or deleting data from the data retrieved by the retrieval module 482.

Referring to FIG. 10B, a method of updating a multimedia document 10 having a hierarchical structure is shown generally as 490 and commences at step 491.

At step 492, a user selects a structural element 15 which contains data that the user may wish to modify.

At step 494, retrieval module 482 retrieves data for that structural element 15 from the multimedia document 10, and displays that data to the user. This may require the hierarchy of the multimedia document 10 to be traversed and searched to locate the desired structural element 15. Different traversal and search algorithms as known may be used for this purpose.

At step 496, optionally, the user makes modifications to the data. Modifications to the data (e.g., changes, additions, deletions) are submitted to the update module 488 through an input device 486.

At step 498, the update module 488 stores the modifications to the data in the structural element 15 selected at step 492.

Step 500 marks the end of the method for updating a multimedia document 10 having a hierarchical structure.

In variant embodiments of the system 480 and method 490 for updating a multimedia document 10, various techniques for facilitating more efficient updating of data as known in the prior art (e.g. tracking dirty data, caching techniques, etc.) can be employed.

In variant embodiments of the system 480 and method 490 for updating a multimedia document 10, a user is not limited to selecting one specific structural element 15, but instead, the user can select a specific text element 65 or content element 70 for editing, or alternatively, multiple structural elements 15 for editing.

The system 480 of FIG. 10A and the method 490 of FIG. 10B for updating a multimedia document 10 having a hierarchical structure have the advantage of allowing modifications to be made to multimedia documents containing digital video data (e.g., movies) more efficiently in some instances, particularly if the desired changes are simple and only require the modification of data for a specific low-level component (e.g. changes to the data of a single voiceover 75 in a shot 50 or a single image). The modular nature of the multimedia document 10 having a hierarchical structure can be advantageously utilized to permit changes to be made without requiring data in other structural elements to be accessed or retrieved.

In variant embodiments of the invention, because the multimedia document 10 has a hierarchical or tree-like structure, multiple authors may work simultaneously to create or modify different structural elements 15 within a document. Each author would make changes to particular nodes in the tree-like structure of the multimedia document 10, which could then be merged into the main tree-like structure using existing XML tools.

In variant embodiments of the invention, other applications using a multimedia document 10 having a hierarchical structure are possible.

With respect to the elements of the systems described in this specification, it will be apparent to those skilled in the art that the execution of various tasks need not be performed by the particular component specified in the description of the preferred embodiment of the invention. It will also be apparent to those skilled in the art that the components of these systems need not reside on the specific computing machine or device as described in this specification, and need not be implemented in the specific manner as described in the specification. For example, the components of the systems may physically reside on a single computing device, or may be distributed across multiple computing devices. Data stored in databases may be stored in a single database, or distributed across several databases or other storage means. The connections in the systems can be maintained by any data communication means as is known, including Ethernet network connections, TCP/IP connections, wireless communication means, or other known connection means. The tasks performed by a particular module in these systems may instead be performed by multiple modules, or by a module different than that suggested in this specification.

As will be apparent to those skilled in the art, other variations, modifications and adaptations of the systems and methods described herein are possible without departing from the present invention, the scope of which is defined in the claims.

1. A method of searching a multimedia document, said multimedia document comprising digital video data, said method comprising the steps of:
a) searching text data in a multimedia document according to a user-defined query, wherein said multimedia document has a hierarchical structure comprising a plurality of structural elements, and wherein at least one of said structural elements comprises text data; and
b) displaying to a user the result obtained in the performance of step (a).

2. A method of using digital video data to answer frequently asked questions displayed on a web page, said method comprising:
a) creating a multimedia document having a hierarchical structure, said multimedia document comprising a plurality of structural elements, wherein at least one of said structural elements contains digital video data;
b) displaying a web page containing frequently asked questions to a user;
c) receiving input from the user identifying a user-selected frequently asked question contained in said web page;
d) retrieving data from said multimedia document, said data associated with an answer to said user-selected frequently asked question; and
e) outputting data retrieved in step (d) to said user.

3. A method of publishing a multimedia document, said multimedia document comprising digital video data, /said method comprising the steps of:
a) creating a movie from a multimedia document, said movie comprising a plurality of structural elements, said plurality of structural elements comprising a plurality of tracks, each of said plurality of tracks containing data from said multimedia document and timing information;
b) processing said movie, wherein said processing step includes partitioning said movie into a plurality of movie components; and
c) generating at least one output document in a web-based language, said output document capable of being processed by a web browser for viewing by a user, said output document permitting said user to receive output of at least one of said movie components as selected by said user.

4. The method as claimed in claim 3, wherein said web-based language is selected from the group consisting of: Hypertext Markup Language, Structured Multimedia Integration Language, and Wireless Markup Language.

5. The method as claimed in claim 3, wherein said method also comprises the step of selecting an output format for said movie, wherein said output format is selected from the group consisting of: QuickTime, AVI, Windows Media, and Real Media.

6. The method as claimed in claim 3, wherein said method also comprises the step of selecting at least one document template from a plurality of document templates for use in said generating step.

7. The method as claimed in claim 3, wherein said processing step also includes a compressing step wherein the data of at least one track of said plurality of tracks is compressed, and wherein said method further comprises the step of decompressing the data of at least one track of the at least one of said movie components selected by said user.

8. The method as claimed in claim 7, wherein said compressing step includes selecting a compression algorithm from a plurality of compression algorithms for use in said compressing step.

9. The method as claimed in claim 7, wherein said compressing step includes determining an optimal compression algorithm for use in said compressing step.

10. The method as claimed in claim 3, wherein said method also comprises the step of connecting each of said plurality of movie components with an identifying element.

11. The method as claimed in claim 10, wherein said identifying element is a graphic capable of being viewed by said user.

12. The method as claimed in claim 3, wherein said method also comprises a document creating step, wherein a multimedia document having a hierarchical structure is created.

13. The method as claimed in claim 12, wherein said multimedia document represents a movie comprising a plurality of first structural elements, wherein each of said first structural elements comprises at least one of the following: a second structural element, a text element, and a content element.

14. The method as claimed in claim 12, wherein said document creating step is performed by a plurality of authors, wherein each author creates a part of said multimedia document.

15. The method as claimed in claim 3, wherein said multimedia document comprises a variant element for use in generating output documents from a multimedia document in a plurality of formats.

16. The method as claimed in claim 15, wherein said generating step uses said variant element to generate at least one output document in English, and at least one output document in French.

17. The method as claimed in claim 15, wherein said generating step uses said variant element to generate a plurality of output documents associated with one of: a plurality of operating system platforms, a plurality of data transfer rates, and a plurality of expertise levels.

18. The method as claimed in claim 3, wherein said method also comprises a delivering step wherein said at least one output document is transmitted to said user via a data communications network.

19. The method as claimed in claim 18, wherein said at least one output document consists of a single HTML page, said single HTML page comprising hypertext links for accessing output of at least one of said movie components.

20. A method of navigating a multimedia document, said multimedia document comprising digital video data, said method comprising the steps of:
a) searching text data in a multimedia document, wherein said multimedia document has a hierarchical structure comprising a plurality of structural elements, and wherein at least one of said structural elements comprises text data;
b) creating a navigation index comprising a plurality of index elements using said text data;
c) retrieving data from said multimedia document, said data being associated with a user-selected index element; and
d) outputting the data retrieved in c) to a user.

21. The method as claimed in claim 20, wherein the navigation index is selected from the group consisting of: an index, and a table of contents.

22. A method of updating a multimedia document, said multimedia document comprising digital video data, said multimedia document having a hierarchical structure comprising a plurality of structural elements, said method comprising the steps of:
a) selecting a structural element in the multimedia document;
b) retrieving data stored in the structural element selected in step a);
c) amending said data retrieved in step b); and
d) storing the data as amended in c) in the structural element selected in step a).

23. A system for publishing multimedia documents, said multimedia documents comprising digital video data, said system comprising:
a) a first module for creating a movie from a multimedia document, said movie comprising a plurality of structural elements, said plurality of structural elements comprising a plurality of tracks, each of said plurality of tracks containing data from said multimedia document and timing information;
b) a second module connected to said first module for processing said movie, wherein said movie is partitioned into a plurality of movie components;
c) a third module connected to said second module for generating at least one output document in a web-based language; and
d) a web browser connected to said third module for processing said output document and displaying said output document to a user, wherein said output document permits said user to receive output of at least one of said movie components selected by said user.

24. The system as claimed in claim 23, wherein said web-based language is selected from the group consisting of: Hypertext Markup Language, Structured Multimedia Integration Language, and Wireless Markup Language.

25. The system as claimed in claim 23, wherein said system also comprises a fourth module connected to said web browser, said fourth module used to transmit output of the at least one of said movie components to a user in a specified output format, wherein said output format is selected from the group consisting of: QuickTime, AVI, Windows Media, and Real Media.

26. The system as claimed in claim 23, wherein said third module generates said at least one output document using at least one document template selected from a plurality of document templates.

27. The system as claimed in claim 23, wherein said system also comprises a compression module for compressing the data of at least one track of said plurality of tracks, and wherein said system also comprises a decompression module for decompressing compressed data.

28. The system as claimed in claim 23, wherein the processing performed by said second module also comprises connecting each of said plurality of movie components with an identifying element.

29. The system as claimed in claim 28, wherein said identifying element is a graphic capable of being viewed by said user.

30. The system as claimed in claim 23, wherein said system also comprises an application for creating a multimedia document, said multimedia document having a hierarchical structure.

31. The system as claimed in claim 30, wherein said multimedia document represents a movie comprising a plurality of first structural elements, wherein each of said first structural elements comprises at least one of the following: a second structural element, a text element, and a content element.

32. The system as claimed in claim 31, wherein said multimedia document comprises text data, wherein said system comprises a search module, and wherein said text data can be searched using said search module.

33. The system as claimed in claim 32, wherein said system comprises a database for storing text data which can be searched using user-defined queries.

34. The system as claimed in claim 30, wherein said application is adapted to permit each of a plurality of authors to create a part of said multimedia document.

35. The system as claimed in claim 30, wherein said multimedia document is a document containing frequently asked questions.

36. The system as claimed in claim 23, wherein said multimedia document comprises a variant element for use in generating output documents from a multimedia document in a plurality of formats.

37. The system as claimed in claim 36, wherein said variant element is used to generate at least one output document in English and at least one output document in French.

38. The system as claimed in claim 36, wherein said variant element permit generation of a plurality of output documents associated with one of: a plurality of operating system platforms, a plurality of data transfer rates, and a plurality of expertise levels.

39. The system as claimed in claim 23, wherein said system also comprises a module adapted to transmit said at least one output document to said user via a data communications network.

40. The system as claimed in claim 39, wherein said at least one output document consists of a single HTML page, said single HTML page comprising hypertext links for accessing output of at least one of said movie components.

41. The system as claimed in claim 23, further comprising: a module programmed to create a navigation index for processing text in said multimedia document, said navigation index comprising a plurality of index components; and a module programmed to retrieve data in said multimedia document associated with a user-selected index components of said navigation index, and to output said data to a user.

42. The system as claimed in claim 23, further comprising: a module programmed to retrieve data stored in a selected structural element of said multimedia document; and a module programmed to receive modifications to said data from a user, and saving the data as modified by said user in said selected structural element.

43. A computer-readable medium having stored thereon computer-executable instructions for publishing multimedia documents comprising digital video data by performing the steps of:
a) creating a movie from a multimedia document, said movie comprising a plurality of structural elements, said plurality of structural elements comprising a plurality of tracks, each of said plurality of tracks containing data from said multimedia document and timing information;
b) processing said movie, wherein said processing step includes partitioning said movie into a plurality of movie components; and
c) generating at least one output document in a web-based language, said output document capable of being processed by a web browser for viewing by a user, said output document permitting said user to receive output of at least one of said movie components as selected by said user.
